(19) United States
(12) Patent Application Publication
(10) Pub. No.: US 2023/0334038 A1
(43) Pub. Date: Oct. 19, 2023

(54) MULTI-JURISDICTIONAL INFORMATION SHARING

(71) Applicants: University College Dublin, Dublin (IE); Inlecom Group BVBA, Brussels (BE)

(72) Inventors: Ibad Kureshi, Spennymoor (GB); Raymond James Genoe, Wicklow (IE); Robert Michael Dowdall, Louth (IE); Cormac James Doherty, Skerries (IE); Antonios Mygiakis, Athens (GR)

(73) Assignees: University College Dublin, National University of Ireland, Dublin, Dublin (IE); Inlecom Group BVBA, Brussels (BE)

(21) Appl. No.: 17/720,046

(22) Filed: Apr. 13, 2022

(51) Int. Cl. G06F 16/23; G06F 16/27; G06F 16/2453; G06F 40/279

(52) U.S. Cl. CPC G06F 16/2365; G06F 16/2358; G06F 16/27; G06F 16/24545; G06F 40/279

(57) ABSTRACT

Multi jurisdictional data sharing includes ingesting data sharing regulations for respectively different political jurisdictions and parsing each of the regulations into a corpus of regulatory text with portions of the corpus having been normalized into different sets of uniform regulations for corresponding ones of the different political jurisdictions. Each of the uniform regulations for each of the political jurisdictions is then matched with one or more applicable data sharing rules and a reference for each of the data sharing rules can be written to a data sharing rules table in association with one or more of the political jurisdictions determined to have uniform regulations matched to the one or more data sharing rules. Consequently, data sharing requests can be restricted as between organizations of one or more implicated political jurisdictions according to each matched data sharing rule in the data sharing rules table that had been associated with the political jurisdictions.

### STATEMENT REGARDING GOVERNMENTALLY SPONSORED RESEARCH OR DEVELOPMENT

The project leading to this application has received funding from the European Union's Horizon 2020 research and innovation programme under grant agreement No 833276.

### BACKGROUND OF THE INVENTION

### Field of the Invention

The present invention relates to the field of information sharing and more particularly to the sharing of information across different political jurisdictional boundaries.

### Description of the Related Art

Data sharing forms the backbone of inter-enterprise computer communications. For general, intra-enterprise computing, the sharing of data amongst different computing systems of a single organization generally is without restriction since the data shared between computing systems can be accessed only by the insiders of the single organization. On the other hand, for inter-enterprise computing, the sharing of data amongst different computing systems of respectively different organizations presents challenges in the form of restricting which data can be accessed by which organization in order to assure data security and data privacy. Solutions for managing information sharing in this instance range from data storage level solutions in which individual tables or records are subject to access control policies, to higher level proxies limiting access to data according to the identity of the requestor without providing direct access to the underlying data store.

Whether or not information sharing is required in the circumstance of intra-enterprise computing, or inter-enterprise computing, the problem of restricting data access compounds when information residing within one political jurisdiction is requested to be accessed in one or more different political jurisdictions. In this regard, as the era of computing advances, more and more political entities have advanced government policy with respect to desired levels of data privacy and data security through government regulation. Consequently, it is now imperative that an enterprise application providing multi jurisdictional data access consider the situs of requested data, the transient locations of data en route to a destination and the situs of data once received when processing data access requests.

The process of information sharing in the context of law enforcement necessarily invokes the concerns of adhering to jurisdictional norms of data access limitations when information sharing across jurisdictional boundaries. Yet, the notion of inter-jurisdictional information sharing in the context of law enforcement is nothing less than a core requirement for the success of cooperative law enforcement efforts. A failure to adequately share information amongst different law enforcement agencies in different political jurisdictions can otherwise act to defeat a given law enforcement effort otherwise likely to be successful given an opportunity to access pertinent information collected by a counterpart law enforcement agency in a different political jurisdiction.

### BRIEF SUMMARY OF THE INVENTION

Embodiments of the present invention address deficiencies of the art in respect to data sharing across different jurisdictional boundaries and provide a novel and non-obvious method, system and computer program product for multi jurisdictional data sharing. In an embodiment of the invention, a method for the multi jurisdictional sharing of data includes ingesting into a data store of a host computing platform, data sharing regulations for respectively different political jurisdictions. Each of the regulations may then be parsed into a corpus of regulatory text. Different portions of the regulatory text are then normalized into different sets of uniform regulations for corresponding ones of the political jurisdictions. Finally, each of the uniform regulations for each of the political jurisdictions may then be matched with one or more corresponding data sharing rules and each matched data sharing rule may be associated, in a data sharing rules table of the data store, with one or more of the political jurisdictions corresponding to the matching uniform regulations.

Thereafter, a data sharing request between organizations associated with a set of one or more of the political jurisdictions can be received. In response to the data sharing request, the data sharing rules table may be queried with the set of the one or more of the political jurisdictions in order to retrieve one or more of the data sharing rules applicable for the set of the political jurisdictions. Finally, a response to the data sharing request is restricted according to the retrieved data sharing rules. In this way, the data sharing regulations published for each of the political jurisdictions in the set can be enforced autonomically and in a uniform way without regard to the specific language used in publishing the data sharing regulations of each jurisdiction, the specific grammar used to express the data sharing regulations of each jurisdiction, or even the propensity of those data sharing regulations to change from time to time.

In one aspect of the embodiment, the data sharing regulations are ingested by recording a network address pointing to a repository of the data sharing regulations and the data sharing regulations are retrieved from over a computer communications network into the data store. As such, in another aspect of the embodiment, the repository of the data may be monitored from over the computer communications network, so as to detect a change in the data sharing regulations at the repository. In response, the ingesting step can be re-performed so as to maintain a current set of data sharing regulations for each of the political jurisdictions and a current mapping between a uniform expression of the data sharing regulations and the applicable data sharing rules.

In another aspect of the embodiment, a conflict can be detected between two of the matched data sharing rules associated with one or more of the political jurisdictions for a corresponding data sharing request. As such, a conflicts resolution rule may be retrieved from a conflicts resolution table in the data store, that has been associated with the one or more political jurisdictions. Thereafter, the retrieved conflicts resolution rule may be applied to the two of the matched data sharing rules so as to exclude one of the two of the matched data sharing rules from application to the corresponding one of the data sharing requests.

In yet another aspect of the embodiment, a request can be received in the host computing platform to update one of the data sharing regulations for a corresponding one of the political jurisdictions. In response, the update can be normalized into a new uniform regulation. Then a new rule is defined for the new uniform regulation and the new rule published in the host computing platform. Subsequently, in response to a receipt of a threshold number of votes accepting the new rule, the new rule can be stored in the data sharing rules table in connection with the corresponding one of the political jurisdictions. In this way, the data sharing rules table adapts to constantly changing data sharing regulations in different political jurisdictions in an autonomic manner.

In another embodiment of the invention, a data processing system is adapted for multi jurisdictional data sharing. The system includes a host computing platform having one or more computers, each with memory and at least one processor. The system also includes a data sharing module that includes computer program instructions. The instructions are enabled while executing in the host computing platform to ingest into a data store of a host computing platform, data sharing regulations for respectively different political jurisdictions, to parse each of the regulations into a corpus of regulatory text and to normalize portions of the regulatory text into different sets of uniform regulations for corresponding ones of the political jurisdictions. The instructions also are enabled to match each of the uniform regulations for each of the political jurisdictions with one or more corresponding ones of a multiplicity of data sharing rules and to associate in a data sharing rules table of the data store, each matched data sharing rule with one or more of the political jurisdictions with ones of the uniform regulations matching the matched data sharing rule. Finally, the instructions are enabled to respond data sharing requests between organizations of one or more of the political jurisdictions according to each of the matched data sharing rules in the data sharing rules table associated with the one or more political jurisdictions.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial depiction of a multi jurisdictional data sharing process;

FIG. 2 is a schematic diagram of a computer data processing system adapted for multi jurisdictional data sharing; and,

FIG. 3 is a flow chart illustrating a process for multi jurisdictional data sharing.

### DETAILED DESCRIPTION OF THE INVENTION

Embodiments of the invention provide for multi jurisdictional data sharing. In accordance with an embodiment of the invention, the electronically published information sharing regulations of different political jurisdictions are each both extracted into a corpus of text and also normalized into a uniform expression of each regulation for each of the political jurisdictions. Then, different data sharing rules forcing compliance with different ones of the regulations are mapped to specific uniform expressions of the regulations, and by extension, a corresponding set of one or more associated political jurisdictions. As such, upon receiving a request to access data in one political jurisdiction by a requestor sited in another political jurisdiction, by reference to both specified political jurisdictions, the data sharing rules applicable to the regulations of each of the jurisdictions are located and automatically applied to the received request so as to assure conformance with the information sharing regulations of both jurisdictions without requiring an individual to maintain an unreasonable awareness of all possible information sharing regulations in all jurisdictions associated with each of many data access requests.

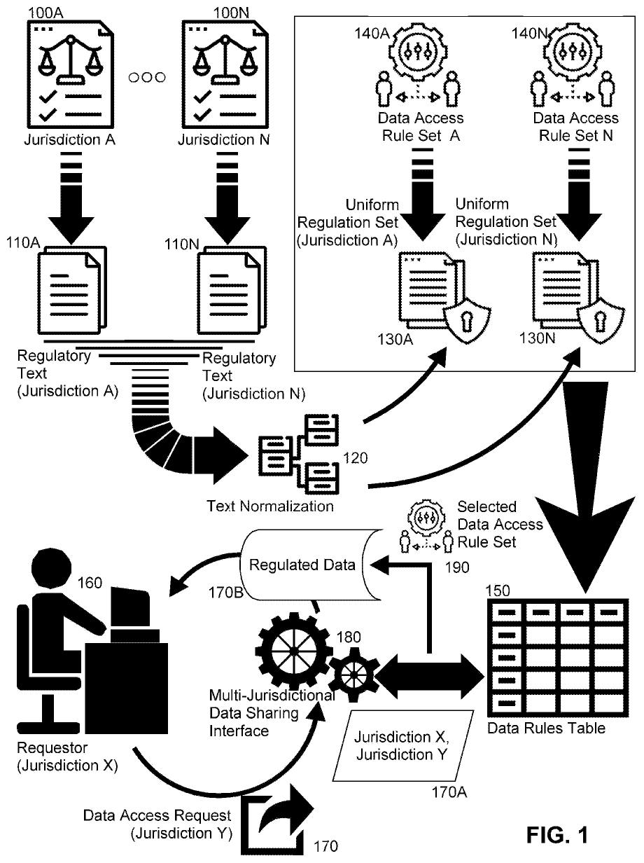

In further illustration, FIG. 1 pictorial shows a multi jurisdictional data sharing process. As shown in FIG. 1, different regulatory documents 100A, 100N of correspondingly different political jurisdictions are parsed into regulatory text 110A, 110N and then subjected to text normalization 120 so as to identify different regulatory statements within the regulatory text 110A, 110N, and to substitute words and phrases of the statements into uniform representations of the words and phrases so as to produce a uniform regulation set 130A, 130N for each corresponding one of the political jurisdictions. Then, one or more rules in a data access rule set 140A, 140N are mapped to each of the uniform representations of the words and phrases in a data rules table 150 so that each uniform regulation set 130A, 130N has a corresponding data rule access set 140A, 140N.

Thereafter, a requestor 160 associated with an originating political jurisdiction issues a data access request 170 to a multi jurisdictional data sharing interface 180 to access data present in a target political jurisdiction. The multi jurisdictional data sharing interface 180 resolves an identity for both the originating political jurisdiction and the target political jurisdiction and provides the resolved identity as key 170A to the data rules table 150 in order to retrieve a selected data access rule set 190, from amongst the data access rule sets 140A, 140N, that is pertinent to the originating and target political jurisdictions. The multi jurisdictional data sharing interface 180 then applies the selected data access rule set 190 to the data access request 170 in order to limit a result set 170B produced by the request 170 so as to be in conformance with those of the uniform regulation sets 130A, 130N of the originating and target political organizations.

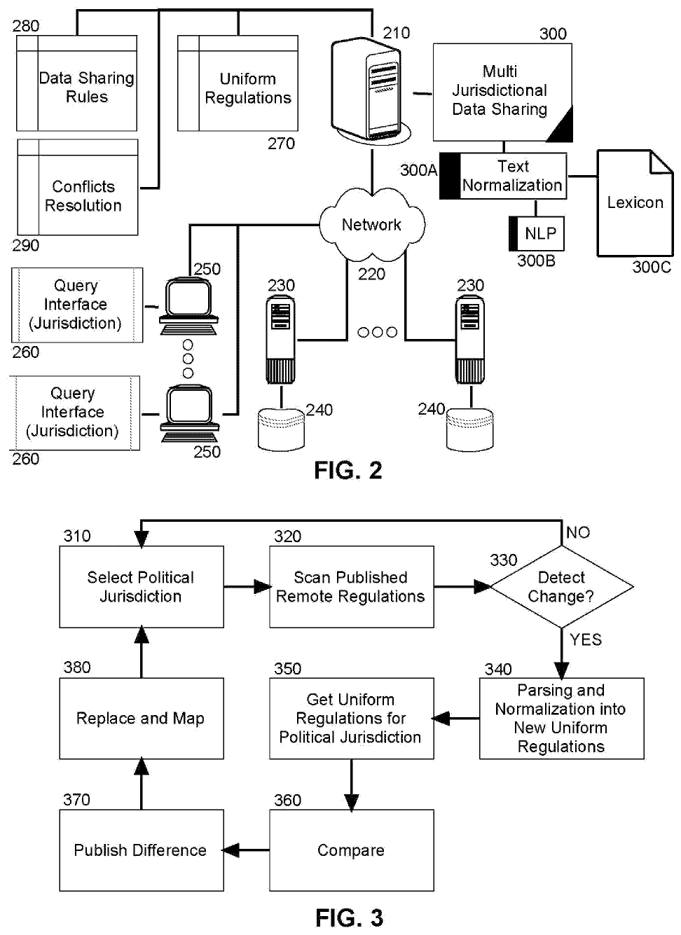

The process described in connection with FIG. 1 can be implemented within a computer data processing system. In more particular illustration, FIG. 2 schematically shows a computer data processing system adapted for multi jurisdictional data sharing. The system includes a host computing platform 210 that includes one or more computers, each with memory and at least one processor. The host computing platform 210 is communicatively coupled to different data sources 230 over computer communications network 220, each of the data sources 230 providing data access to records within a corresponding data store 240. In this regard, each of the data sources 230 provides content relating to the regulatory documentation for correspondingly different political jurisdictions. For instance, the content can be a set of records in a database in the data store 240, or one or more documents stored in the data store 240, or one or more Web pages stored in the data store 240 and served to requestors over the computer communications network 220.

The system also includes a table of uniform regulations 270. The table of uniform regulations 270 provides a set of different uniform statements of data sharing regulations. Each of the uniform statements in the table of uniform regulations 270 refers to one or more specific regulations present in corresponding regulatory documentation for one or more of the correspondingly different political jurisdictions. In addition to the table of uniform regulations 270, a table of data sharing rules 280 is provided. The table of data sharing rules 280 includes different rules limiting access to data in response to a data request, such as rules requiring the removal from a result set of personally identifying information including a name or government identification number, a telephone number or an address. Other rules include a denial of a data sharing request for specific information types.

Optionally, a new data sharing rule can be provided in the host computing platform 210 and published for review by different end users in association with one or more specified uniform regulations in the table of uniform regulations 270. Subsequently, in response to having received a threshold number of assenting messages from the different end users agreeing to the association of the new data sharing rule with the one or more specified uniform statements, the new data sharing rule can be stored in the table of data sharing rules 280 and mapped to the one or more specified uniform statements in the table of uniform regulations 270.

Finally, a conflicts resolution table 290 is provided. The conflicts resolution table 290 includes rules determining which of two conflicting entries in the table of data sharing rules 280 are to apply when both entries are implicated for a data access request. Rules in the conflict resolution table 290, for instance, can specify that a more restrictive one of the data sharing rules 280 prevails, to name one possibility.

Of import, the system includes a multi jurisdictional data sharing module 300. The module 300 includes computer program instructions enabled to periodically retrieve from over the computer communications network 220 from the different data stores 240 of the different data sources 230, different regulatory documentation. In this regard, the program instructions, when supplied with a network address for each of the data sources 230, can be enabled to request retrieval of the regulatory documentation with which the program instructions are enabled to apply text normalization logic 300A to a parsed form of the documentation utilizing natural language processor 300B supplemented with a lexicon 300C of uniform terms and phrases each equated to a different set of synonymous terms and phrases. In this way, the parsed text of the regulatory documentation can be segmented into different statements and the different statements can then be normalized into a uniform expression thereof.

Ultimately, the program instructions store each uniform expression for a corresponding regulatory statement into the table of uniform regulations 270. Thereafter, the program instructions map one or more of the data sharing rules in the table of data sharing rules 280 to each corresponding uniform statement in the table of uniform regulations 270. Finally, each of the uniform statements is associated with one or more political jurisdictions so that a query to the table of uniform regulations 270 with a specified political jurisdiction returns all uniform statements in the table of uniform regulations 270 that are associated with the specified political jurisdiction. Consequently, all mapped ones of the data sharing rules in the table of data sharing rules 280 may then be acquired for the specified political jurisdiction. In this way, a loose coupling of data sharing rules to uniform statements may be established without fixing a specific relationship between political jurisdiction and data sharing rule in so far as the data sharing rules for a uniform statement may change from time to time as can the uniform statements for a political jurisdiction change from time to time.

Notably, the program instructions of the module 300 thereafter are enabled upon execution in the memory of the host computing platform 210 to receive through a query interface 260 of a computing client 250 within an originating political jurisdiction, a data access request directed to data residing in a target. political jurisdiction which may be the same or different than the originating political jurisdiction. The program instructions, in response, query the table of uniform regulations 270 with the originating and target jurisdictions in order to extract an applicable set of uniform regulations. Then, the program instructions query the table of data sharing rules 280 in order to extract a set of applicable data sharing rules for the applicable set of uniform regulations.

To the extent that different ones of the data sharing rules in the applicable set provide opposite or otherwise conflicting directives, the program instructions submit the conflicting ones of the data sharing rules to the conflicts resolution table 290 in order to determine which of the conflicting ones of the data sharing rules are to be discarded. Finally, the program instructions modify the data access request in conformance with the data sharing rules in the applicable set in order to produce a result set for return to the computing client 250.

In even further illustration of the operation of the multi jurisdictional data sharing module 300, FIG. 3 is a flow chart illustrating a process for multi jurisdictional data sharing. Beginning in block 310, a political jurisdiction is selected and in block 320, a network address for the selected political jurisdiction is retrieved and used to query a remote repository of published data sharing regulations, such as a Web site incorporating the data sharing regulations for the selected political jurisdiction, a network accessible document incorporating therein the data sharing regulations for the selected political jurisdiction, or a database from which different data sharing regulations for the selected political jurisdiction can be extracted by query.

In decision block 330, it is determined if a change has occurred between a last determined set of data sharing regulations for the selected political jurisdiction and the data sharing regulations contemporaneously accessed at the network address. If not, a next political jurisdiction is selected in block 310 and the process repeats through block 320. But, if it is determined in decision block 330 that the last determined set of data sharing regulations has since changed, in block 340 the data sharing regulations accessed at the network address are retrieved into a corpus of text, segmented into different statements and normalized into a set of uniform statements.

In block 350, a contemporaneous set of uniform statements for the selected political jurisdiction are retrieved and in block 360 the set of uniform statements produced in block 340 are then compared to the contemporaneous set of uniform statements for the selected jurisdiction so as to determine a difference in the statements. In block 370, the difference in statements are then published to a display for review by at least one end user and in block 380, the changed ones of the contemporaneous statements are removed from the table of uniform regulations and replaced with the new and/or different uniform statements produced in block 340. Thereafter, the process returns to block 310 for a next political jurisdiction.

The present invention may be embodied within a system, a method, a computer program product or any combination thereof. The computer program product may include a non-transitory computer readable storage medium or media having computer readable program instructions stored thereon, which when executed within the computer, cause one or more processors to perform different processes exemplary of different aspects of the present invention. To that end, the non-transitory computer readable storage medium can be a tangible device that can retain and store instructions for use by an instruction execution device such as a processor (central processing unit or “CPU”).

Aside from direct loading from memory for execution by one or more cores of a CPU or multiple CPUs, the computer readable program instructions described herein alternatively can be downloaded from over a computer communications network into the memory of a computer for execution therein. As well, only a portion of the program instructions may be retrieved into memory of the computing device from over a computer communications network, while other portions may be loaded from persistent storage of the computing device. Even further, only a portion of the program instructions may execute by one or more processing cores of one or more CPUs of the computing devices while other portions may cooperatively execute within a different computing device positioned remotely over the computer communications network with results of the computing by both devices shared therebetween.

Even yet further, as it is to be understood, one or more aspects of the present invention have been described herein with reference to flowchart illustrations and/or block diagrams of methods, apparatus (data processing systems), and computer program products according to embodiments of the invention. It will be understood that each block of the flowchart illustrations and/or block diagrams, and combinations of blocks in the flowchart illustrations and/or block diagrams, can be implemented by computer readable program instructions in various combinations. These computer readable program instructions may be provided to a CPU of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method multi jurisdictional data sharing comprising:
ingesting into a data store of a host computing platform, data sharing regulations for respectively different political jurisdictions;
parsing each of the regulations into a corpus of regulatory text and normalizing portions of the regulatory text into different sets of uniform regulations for corresponding ones of the political jurisdictions;
matching each of the uniform regulations for each of the political jurisdictions with one or more corresponding ones of a multiplicity of data sharing rules and associating each matched data sharing rule, in a data sharing rules table of the data store, with ones of the political jurisdiction corresponding to the matching uniform regulations;
receiving a data sharing request between organizations associated with a set of one or more of the political jurisdictions and querying the data sharing rules table with the set of the one or more of the political jurisdictions in order to retrieve one or more of the data sharing rules applicable for the set of the political jurisdictions; and,
restricting a response to the data sharing request according to the retrieved one or more of the data sharing rules.

2. The method of claim 1, wherein the data sharing regulations are ingested by recording a network address pointing to a repository of the data sharing regulations and retrieving the data sharing regulations from over a computer communications network into the data store.

3. The method of claim 2, further comprising monitoring the repository of the data from over the computer communications network, detecting a change in the data sharing regulations at the repository and re-performing the ingesting responsive to the detected change.

4. The method of claim 1, further comprising:
detecting a conflict between two of the matched data sharing rules associated with the one or more political jurisdictions for a corresponding one of the data sharing requests;
retrieving from a conflicts resolution table in the data store, a conflicts resolution rule associated for the one or more political jurisdictions; and,
applying the retrieved conflicts resolution rule to the two of the matched data sharing rules so as to exclude one of the two of the matched data sharing rules from application to the corresponding one of the data sharing requests.

5. The method of claim 1, further comprising:
receiving a request in the host computing platform to update one of the data sharing regulations for a corresponding one of the political jurisdictions;
normalizing the update into a new uniform regulation;
defining a new rule for the new uniform regulation;
publishing the new rule and new uniform regulation in the host computing platform; and,
responsive to a receipt of a threshold number of votes accepting the new rule, storing the new rule in the data sharing rules table in connection with the corresponding one of the political jurisdictions.

6. A data processing system adapted for multi jurisdictional data sharing, the system comprising:
a host computing platform comprising one or more computers, each comprising memory and at least one processor; and,
a data sharing module comprising computer program instructions enabled while executing in the host computing platform to perform:
ingesting into a data store of a host computing platform, data sharing regulations for respectively different political jurisdictions;
parsing each of the regulations into a corpus of regulatory text and normalizing portions of the regulatory text into different sets of uniform regulations for corresponding ones of the political jurisdictions;
matching each of the uniform regulations for each of the political jurisdictions with one or more corresponding ones of a multiplicity of data sharing rules and associating each matched data sharing rule, in a data sharing rules table of the data store, with ones of the political jurisdiction corresponding to the matching uniform regulations;
receiving a data sharing request between organizations associated with a set of one or more of the political jurisdictions and querying the data sharing rules table with the set of the one or more of the political jurisdictions in order to retrieve one or more of the data sharing rules applicable for the set of the political jurisdictions; and,
restricting a response to the data sharing request according to the retrieved one or more of the data sharing rules.

7. The system of claim 6, wherein the data sharing regulations are ingested by recording a network address pointing to a repository of the data sharing regulations and retrieving the data sharing regulations from over a computer communications network into the data store.

8. The system of claim 7, wherein the program instructions further perform monitoring the repository of the data from over the computer communications network, detecting a change in the data sharing regulations at the repository and re-performing the ingesting responsive to the detected change.

9. The system of claim 6, wherein the program instructions further perform:
detecting a conflict between two of the matched data sharing rules associated with the one or more political jurisdictions for a corresponding one of the data sharing requests;
retrieving from a conflicts resolution table in the data store, a conflicts resolution rule associated for the one or more political jurisdictions; and,
applying the retrieved conflicts resolution rule to the two of the matched data sharing rules so as to exclude one of the two of the matched data sharing rules from application to the corresponding one of the data sharing requests.

10. The system of claim 6, wherein the instructions further perform:
receiving a request in the host computing platform to update one of the data sharing regulations for a corresponding one of the political jurisdictions;
normalizing the update into a new uniform regulation;
defining a new rule for the new uniform regulation;
publishing the new rule and new uniform regulation in the host computing platform; and,
responsive to a receipt of a threshold number of votes accepting the new rule, storing the new rule in the data sharing rules table in connection with the corresponding one of the political jurisdictions.
